(19) United States
(12) Patent Application Publication
(10) Pub. No.: US 2011/0298737 A1
(43) Pub. Date: Dec. 8, 2011

(54) TOUCH SCREEN DEVICE

(75) Inventors: Takami MAEDA, Fukuoka (JP); Takashi KITADA, Fukuoka (JP); Haruhiko KOHNO, Fukuoka (JP)

(73) Assignee: PANASONIC CORPORATION, Osaka (JP)

(21) Appl. No.: 13/115,383

(22) Filed: May 25, 2011

(30) Foreign Application Priority Data
Jun. 7, 2010 (JP) 2010-129818

(51) Int. Cl. G06F 3/041

(52) U.S. Cl. 345/173

(57) ABSTRACT

A panel main body comprises a plurality of transmitting electrodes provided in parallel to one another and a plurality of receiving electrodes provided in parallel to one another, and the transmitting electrodes and the receiving electrodes being disposed in a grid shape. A transmitter applies pulse signals to the transmitting electrodes, and a receiver receives output signals from the receiving electrodes in response to the pulse signals applied to the transmitting electrodes and outputs level signals at electrode intersections of the transmitting electrodes and the receiving electrodes. A controller detects a touch position based on the level signals output from the receiver. The controller also controls a number of pulses of a pulse signal that the transmitter applies to each transmitting electrode while the receiver receives an output signal from each receiving electrode.

### CROSS-REFERENCE TO RELATED APPLICATIONS

The present application claims priority under 35 U.S.C. §119 of Japanese Application No. 2010-129818 filed on Jun. 7, 2010, the disclosure of which is expressly incorporated by reference herein in its entirety.

### BACKGROUND OF THE INVENTION

1. Field of the Invention

The present invention relates to an electrostatic capacitance touch screen device having electrodes in a grid shape and detecting a touch position based on a change of an output signal from the electrodes associated with a change in electrostatic capacitance in response to a touch operation. In particular, the present invention relates to a mutual capacitance touch screen device receiving charge-discharge current signals flowing through the receiving electrodes in response to driving signals applied to the transmitting electrodes and thus detecting a touch position.

2. Description of Related Art

There are a variety of methods employing different principles to detect a touch position on a touch screen device. In a touch screen device in which numerous electrodes are provided in a panel, such as a projection-type electrostatic capacitance type, the detection level varies depending on a position, mainly due to variation in impedance of the electrodes, and thus the detection accuracy becomes deteriorated. This is mainly attributed to different lengths of lead lines that connect the electrodes to boards.

In particular, a mutual capacitance touch screen device receives charge-discharge current signals flowing through receiving electrodes in response to driving signals applied to transmitting electrodes, and detects a touch position from signal levels obtained through a predetermined signal processing of the charge-discharge current signals. The touch screen device detects the touch position based on changes in the level of signals associated with the touch operation. If there is a substantial variation in the level of signals in a non-touch state, in which no touch operation is performed, the touch screen device cannot detect the touch position with a high accuracy.

To address the decline in detection accuracy due to variation in the level of signals in the non-touch state, a mutual capacitance touch screen device controls voltages of the driving signals applied to the transmitting electrodes (refer to Related Art 1).

A touch screen device, which has widely been used in fields of personal computers and mobile information terminals, can be used as an interactive whiteboard in combination with a large screen display apparatus, the interactive whiteboard being used in a presentation or a lecture for a large audience.

In the case where a touch screen device is used as an interactive whiteboard, the variation in the level of signals is more remarkably observed due to variation in the impedance of the electrodes, which are longer, in accordance with the larger size of the touch screen device. The method above of controlling the voltages of the driving signals applied to the transmitting electrodes cannot effectively reduce the variation of the signal level, thus being unable to ensure sufficient detection accuracy.
[Related Art 1] Japanese Patent Laid-open Publication No. 2008-134836

### SUMMARY OF THE INVENTION

In view of the circumstances above, a main advantage of the present invention is to provide a touch screen device configured to detect a touch position at a high accuracy regardless of a large size.

The present invention provides a touch screen device including a panel main body having a plurality of transmitting electrodes provided in parallel to one another and a plurality of receiving electrodes provided in parallel to one another, and the transmitting electrodes and the receiving electrodes being disposed in a grid shape. A transmitter applies pulse signals to the transmitting electrodes, and a receiver receives output signals from the receiving electrodes in response to the pulse signals applied to the transmitting electrodes and outputs level signals at electrode intersections of the transmitting electrodes and the receiving electrodes. A controller detects a touch position based on the level signals output from the receiver. The controller also controls a number of pulses of a pulse signal that the transmitter applies to each transmitting electrode while the receiver receives an output signal from each receiving electrode.

According to the present invention, the number of pulses of a pulse signal that the transmitter applies to each transmitting electrode while the receiver receives an output signal from each receiving signal is changed, and thus the variation of the level signals can be adjusted in the array direction of the transmitting electrodes. Thereby, a touch position can be detected with a high accuracy.

### BRIEF DESCRIPTION OF THE DRAWINGS

The present invention is further described in the detailed description which follows, in reference to the noted plurality of drawings by way of non-limiting examples of exemplary embodiments of the present invention, in which like reference numerals represent similar parts throughout the several views of the drawings, and wherein:

FIG. 1 is an overall configuration view of a touch screen system to which the present invention is applied;

FIG. 2 is a schematic configuration view of a touch screen device shown in FIG. 1;

FIG. 3 is a schematic configuration view of a pulse generator of a transmitter shown in FIG. 2;

FIG. 4 is a schematic configuration view of a reception signal processor shown in FIG. 3;

FIG. 5 is a circuit diagram illustrating a configuration of an IV converter shown in FIG. 4;

FIGS. 6(a) and 6(b) are each a waveform diagram illustrating a pulse signal applied to transmitting electrodes shown in FIG. 2 and a voltage signal output from the IV converter shown in FIG. 4;

FIG. 7 is a plan view of an electrode sheet included in a panel main body shown in FIG. 1;

FIG. 8 is a plan view illustrating in details a transmission extractor of the electrode sheet shown in FIG. 7;

FIG. 9 illustrates a state in which a pulse signal is applied to the transmitting electrodes in the transmitter shown in FIG. 2;

FIGS. 10(a) and 10(b) each illustrate a pulse signal applied to the transmitting electrodes shown in FIG. 2; output signals from the IV converter, an absolute value detector and an integrator, respectively, of the reception signal processor of the receiver shown in FIG. 4; and a selection signal of receiving electrodes;

FIG. 11 is a flowchart illustrating a procedure to set a frequency of a pulse signal applied to the transmitting electrodes for each group of the transmitting electrodes in a controller shown in FIG. 2;

FIG. 12 is a flowchart illustrating a procedure to set a gain for each group of the receiving electrodes in the controller group in FIG. 2, the gain amplifying output signals from the receiving electrodes in a gain adjuster;

FIGS. 13(a) and 13(b) each illustrate a state of pulse signal control based on the on-duty ratio in the controller shown in FIG. 2;

FIG. 14 illustrates a relationship between the on-duty ratio and the level signal in the pulse signal control based on the on-duty ratio shown in FIGS. 13(a) and 13(b); and

FIGS. 15(a) and 15(b) each illustrate another example of pulse signal control in the touch screen device of the present invention.

### DETAILED DESCRIPTION OF PREFERRED EMBODIMENTS

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show structural details of the present invention in more detail than is necessary for the fundamental understanding of the present invention, the description is taken with the drawings making apparent to those skilled in the art how the forms of the present invention may be embodied in practice.

The embodiment of the present invention is explained below with reference to the drawings.

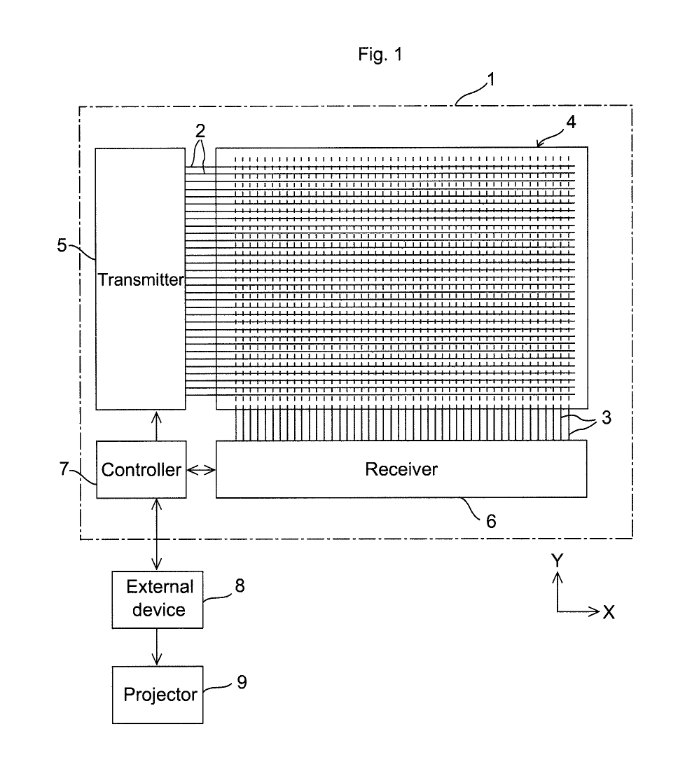

FIG. 1 is an overall configuration view of a touch screen device to which the present invention is applied. The touch screen device 1 has a panel main body 4, a transmitter 5, a receiver 6, and a controller 7. The panel main body 4 includes a plurality of transmitting electrodes 2 provided in parallel to one another and a plurality of receiving electrodes 3 provided in parallel to one another, the transmitting electrodes 2 and the receiving electrodes 3 being disposed in a grid shape. The transmitter 5 applies a driving signal (pulse signal) to the transmitting electrodes 2. The receiver 6 receives a charge-discharge current signal from the receiving electrodes 3 that have responded to the driving signal applied to the transmitting electrodes 2, and outputs a level signal of each electrode intersection of the transmitting electrode 2 and the receiving electrode 3. The controller 7 detects a touch position based on the level signal output from the receiver 6 and controls operations of the transmitter 5 and the receiver 6.

Combined with a large-screen display apparatus, the touch screen device 1 can be used as an interactive whiteboard in a presentation or a lecture. Combined herein in particular with a projector, a touch surface 10 of the touch screen device 1 functions as a screen for the projector.

Touch position information output from the touch screen device 1 is input to an external device 8, such as a personal computer. Based on display screen data output from the external device 8, an image is displayed on a display screen projected and displayed on the touch surface 10 of the touch screen device 1 by the projector 9, the image corresponding to a touch operation performed by a user with a pointing object (user's fingertip or a conductor, such as a stylus or a pointer) on the touch surface 10 of the touch screen device 1. A predetermined image can be displayed in a similar manner to directly draw an image with a marker on the touch surface 10 of the touch screen device. Furthermore, a button displayed on the display screen can be operated. In addition, an eraser can be used to erase an image drawn in a touch operation.

The transmitting electrodes 2 and the receiving electrodes 3 are disposed at the same pitch (10 mm, for example). The number of electrodes is different depending on the aspect ratio of the panel main body 4. For instance, 120 transmitting electrodes 2 and 186 receiving electrodes 3 may be provided.

The transmitting electrodes 2 and the receiving electrodes 3 intersect in a stacked state with an insulating layer (support sheet) in between. A capacitor is formed at the electrode intersection of the transmission electrode 2 and the receiving electrode 3. A user performs a touch operation with a pointing object, and then the electrostatic capacitance at the electrode intersection is substantially reduced accordingly, thus allowing detection of whether a touch operation is performed.

In a mutual capacitance type touch screen device employed herein, a driving signal is applied to the transmitting electrodes 2, and, in response, a charge-discharge current flows in the receiving electrodes 3. A change in the electrostatic capacitance at the electrode intersections at this time in response to a user's touch operation causes a change in the charge-discharge current in the receiving electrodes 3. The change amount of the charge-discharge current is converted, in the receiver 6, to a level signal (digital signal) of each electrode intersection and the level signal is output to the controller 7. The controller 7 calculates a touch position based on the level signal of each electrode intersection. The mutual capacitance type enables multi-touch (multi-point detection) in which a plurality of touch positions are concurrently detected.

The controller 7 obtains the touch position (center coordinate of a touch area) through a predetermined calculation process based on the level signal of each electrode intersection output from the receiver 6. In the touch position calculation, a touch position is obtained from a level signal of each of a plurality of adjacent electrode intersections (for example, 4×4) in the X direction (direction in which the transmitting electrodes 2 extend) and in the Y direction (direction in which the receiving electrodes 3 extend) in a predetermined interpolating method (centroid method, for example). Thereby, the touch position can be detected at a higher resolution (1 mm or less, for example) than the placement pitch (10 mm) of the transmitting electrodes 2 and the receiving electrodes 3.

The controller 7 calculates a touch position every frame period at which reception of a level signal ends for each electrode intersection across the entire surface of the touch surface 10, and outputs the touch position information to the external device 8 in a unit of frame. The external device 8 generates time-line connected display screen data of each touch position based on the touch position information of a plurality of temporally connected frames, and outputs the data to the projector 9. In the case of multi-touch, the touch position information including touch positions by a plurality of pointing objects is output in a unit of frame.

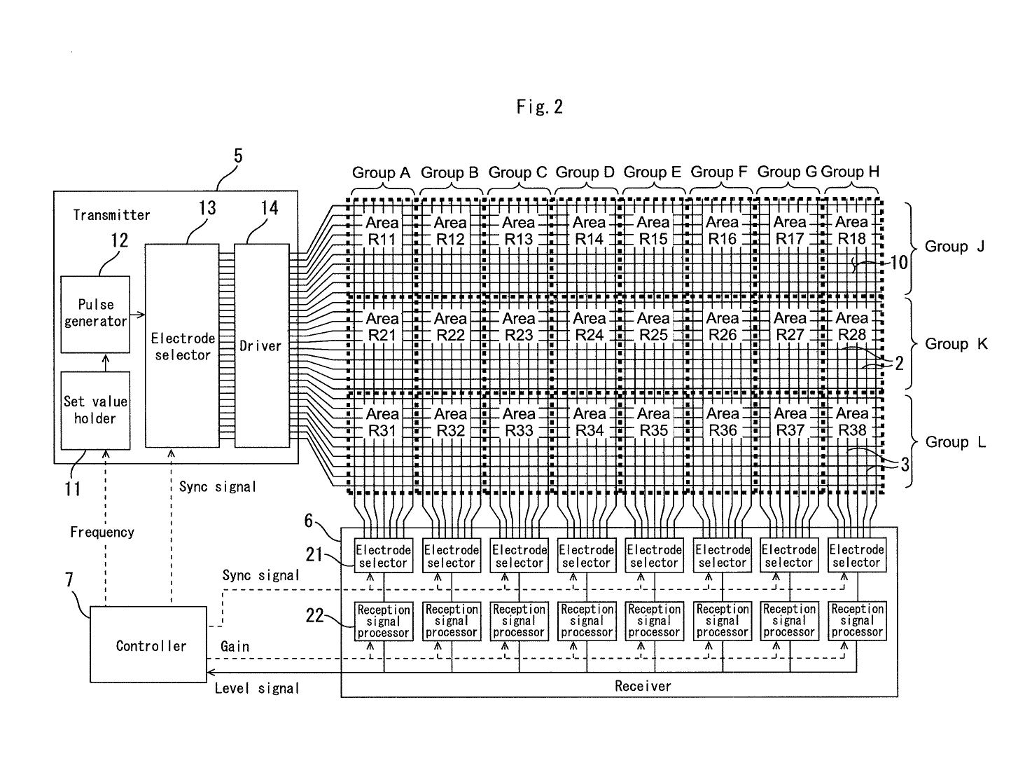

FIG. 2 is a schematic configuration view of the touch screen device 1 shown in FIG. 1. The transmitting electrodes 2 are combined into groups. In this case, 120 transmitting electrodes 2 are divided into three groups of J, K, and L, each of which includes 40 transmitting electrodes 2. The receiving electrodes 3 are combined into groups. In this case, 186 receiving electrodes 3 are divided into eight groups of A to H. The seven groups of A to G of the receiving electrodes 3 each include 24 receiving electrodes 3 and the last group H includes 18 receiving electrodes 3. Of course, different numbers of transmitting and receiving electrodes and different groupings are also possible without departing from the scope of the present invention.

The transmitter 5 selects the transmitting electrodes 2 one by one and sequentially applies a pulse signal (driving signal) to each of the transmitting electrodes 2. The transmitter 5 has a set value holder 11, a pulse generator 12, an electrode selector 13, and a driver 14. The set value holder 11 retains a set value of a pulse signal frequency. The pulse generator 12 generates a pulse at a predetermined timing based on the set frequency value retained in the set value holder 11. The electrode selector 13 applies the pulse output from the pulse generator 12 to the selected transmitting electrode 2 based on a horizontal synchronization signal. The driver 14 drives the selected transmitting electrode 2 with the pulse.

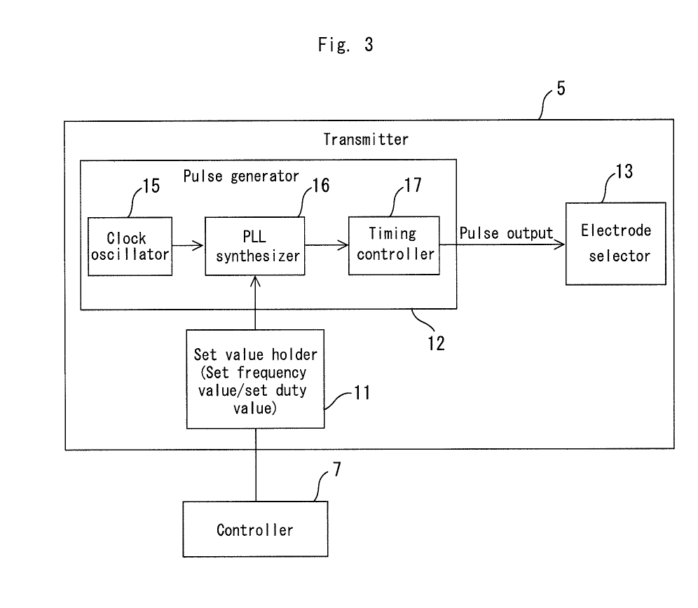

FIG. 3 is a schematic configuration view of the pulse generator 12 of the transmitter 5 shown in FIG. 2. The pulse generator 12 has a clock oscillator 15, a PLL synthesizer 16, and a timing controller 17. The clock oscillator 15 generates a reference clock. The PLL synthesizer 16 outputs a clock pulse, which is generated by converting the reference clock input from the clock oscillator 15 so as to have a frequency based on the set frequency value retained in the set value holder 11. The timing controller 17 outputs the clock pulse output from the PLL synthesizer 16 at a predetermined timing.

The PLL synthesizer 16 is used for frequency conversion herein, but another frequency converter, such as a frequency divider, may be employed.

The set frequency value retained in the set value holder 11 is changed and set by the controller 7. The controller 7 stores in advance, in a ROM, an initial value F0 and candidate values F1 to Fn (n is an integer of 1 or greater) of the pulse signal frequency. To change the pulse signal frequency, the values are retrieved from the ROM and transmitted to the transmitter 5 so as to be set in the set value holder 11. The initial value F0 of the frequency can be 5 MHz, as a non-limiting example. The candidate values Fn are set in constant steps, such as, for example, 5.1 MHz, 5.2 MHz, and so forth. Other values of F1, Fn and the step intervals are also possible.

The number of pulses of one receiving electrode 3, specifically the number of pulses applied to the transmitting electrode 2 during reception of an output signal of one receiving electrode 3, is set for each of the initial value F0 and the candidate values F1 to Fn of the pulse signal frequency. The number of pulses of one receiving electrode 3 is changed according to the change of the frequency. The number of pulses of one receiving electrode 3 is controlled by the timing controller 17.

As shown in FIG. 2, the receiver 6 has an electrode selector 21 and a reception signal processor 22. In the electrode selector 21, a switching element is connected to each of the receiving electrodes 3. While a pulse signal is being applied to one transmitting electrode 2, the receiving electrodes 3 are selected one by one and charge-discharge current signals from the receiving electrodes 3 are sequentially input to the receiving signal processor 22. Thereby, the charge-discharge current signals at all electrode intersections can be retrieved. Each of the switching elements in the electrode selector 21 is individually switched and controlled according to a control signal from the controller 7.

The electrode selector 21 and the signal processor 22 are provided for each group of the receiving electrodes 3. In the electrode selector 21, mutually corresponding switching elements are turned on or off in parallel. In each group, the switching elements are turned on one by one while the remaining switching elements are turned off. A charge-discharge current signal of one receiving electrode 3 selected by turning on the switching element of the electrode selector 21 is input to the reception signal processor 22.

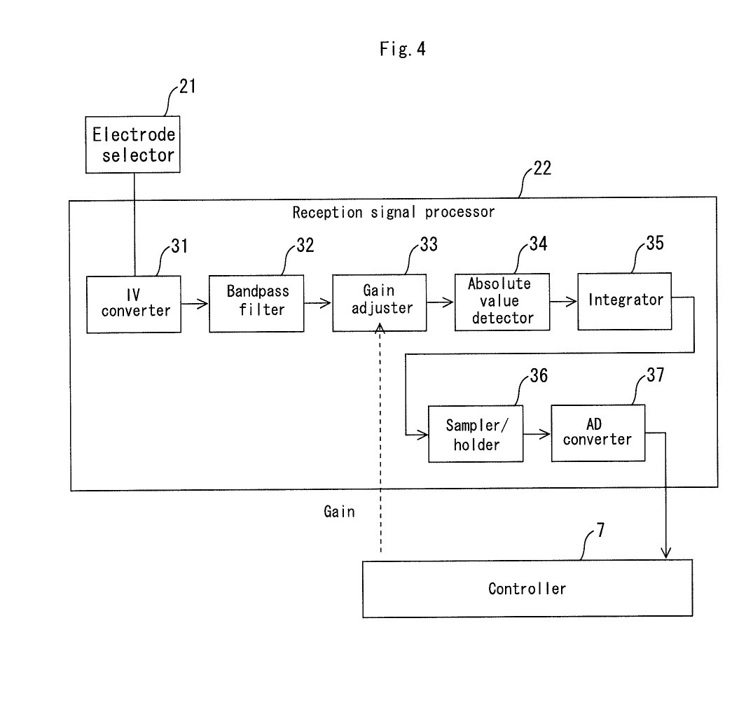

FIG. 4 is a schematic configuration view of the reception signal processor 22 shown in FIG. 3. The reception signal processor 22 has an IV converter 31, a bandpass filter 32, a gain adjuster (amplifier) 33, an absolute value detector 43, an integrator 35, a sampler/holder 36, and an AD converter 37.

The IV converter 31 converts a charge-discharge current signal (analog signal) into a voltage signal, the charge-discharge current signal being input from the receiving electrode 3 through the electrode selector 21. The bandpass filter 32 removes from the output signal from the IV converter 31, a signal having a frequency component other than a frequency of a pulse signal applied to the transmitting electrode 2. The gain adjuster 33 amplifies the output signal from the bandpass filter 32 at a gain set by the controller 7. The absolute value detector (rectifier) 34 performs full-wave rectification of the output signal from the gain adjuster 33. The integrator 35 integrates the output signal from the absolute value detector 34 in a time axis direction. The sampler/holder 36 samples the output signal from the integrator 35 at a predetermined timing. The AD converter 37 AD-converts the output signal from the sampler/holder 36 and outputs a level signal (digital signal).

The gain at the gain adjuster 33 is changed and set by the controller 7. The controller 7 stores in advance, in the ROM, an initial value A0 and a plurality of candidate values A1 to An (n is an integer of 1 or greater) of the gain. To change the gain, the values are retrieved from the ROM and set to the gain adjuster 33.

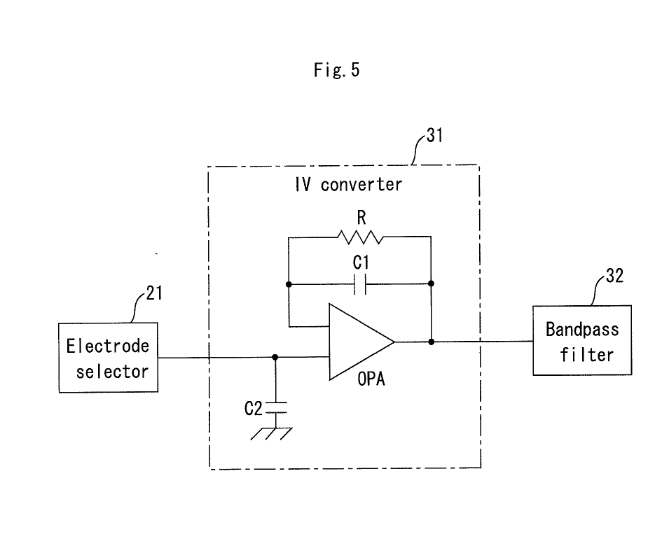

FIG. 5 is a circuit diagram illustrating the configuration of the IV converter 31 shown in FIG. 4. The IV converter 31 has an operational amplifier OPA, a resistance component R, a first capacitor component C1, and a second capacitor component C2. The resistance component R and the first capacitor component C1 are connected in parallel between one of the input sides and the output side of the operational amplifier OPA. The second capacitor component C2 is provided on the other input side of the operational amplifier OPA and grounded.

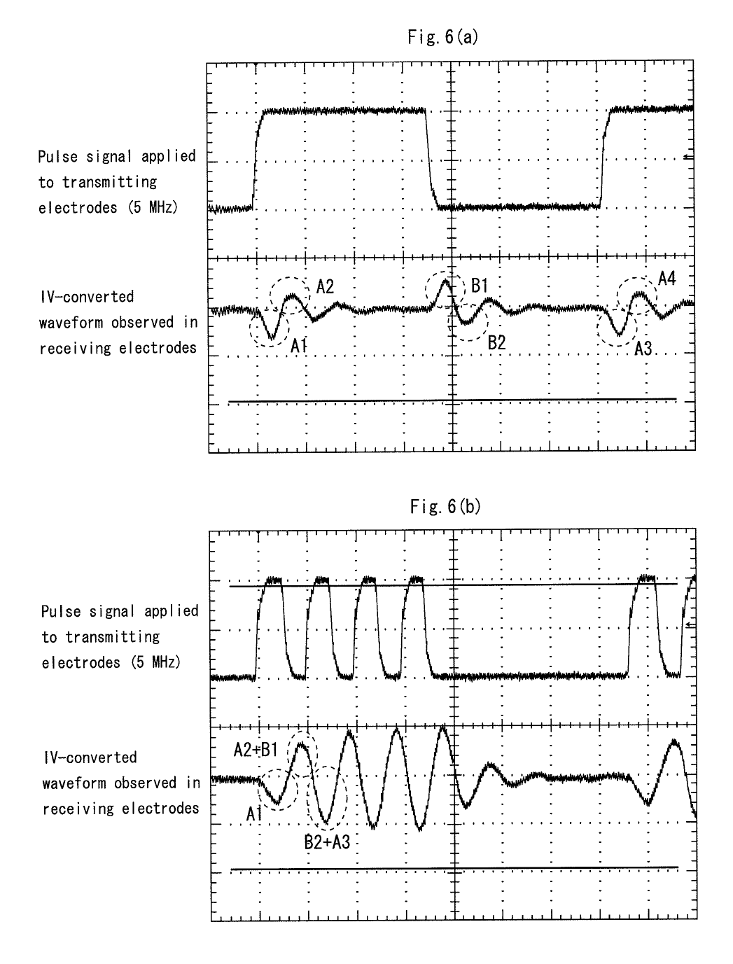

FIGS. 6(a) and 6(b) are waveform diagrams illustrating a pulse signal applied to the transmitting electrodes 2 shown in FIG. 2 and a voltage signal output from the IV converter 31 shown in FIG. 4. FIG. 6(a) illustrates a case of conventional technology, and FIG. 6(b) illustrates the case of the present invention. For convenience, FIG. 6(a) is magnified by roughly 7 times with respect to FIG. 6(b) along the time axis.

In application of the pulse signal to the transmitting electrodes 2, waveforms A1 and A3 are observed on the rise of the pulse wave, as shown in FIG. 6(a), due to charging of the capacitor at the electrode intersection. In a transient response thereto, waveforms A2 and A4 are subsequently observed due to discharging of the capacitor at the electrode intersection. Small waveforms that gradually attenuate are observed thereafter. On the fall of the pulse wave, waveform B1 is observed due to discharging of the capacitor at the electrode intersection. In a transient response thereto, waveform B2 is subsequently observed due to charging of the capacitor at the electrode intersection. Small waveforms that gradually attenuate are observed thereafter.

A touch operation at this point reduces the electrostatic capacitance of the capacitor at the electrode intersection. The amplitude of the voltage signal output from the IV converter 31 is thus reduced. Thereby, whether a touch operation is performed can be determined based on a change of a crest wave. The touch screen device 1, which is used as an interactive whiteboard, has a large electrostatic capacitance as a whole between the transmitting electrodes 2 and the receiving electrodes 3 due to the large size of the device. The change in the electrostatic capacitance caused by a touch operation is thus extremely small relative to the total electrostatic capacitance. For this reason, the amplitude of the voltage signal is barely decreased when the touch operation occurs, and accuracy in detecting a touch position declines.

The IV converter 31 is thus set to have a conversion property such that the amplitude phase of voltage signals is substantially matched, the voltage signals being output from the IV converter 31 corresponding to the rise and fall of one pulse wave of a pulse signal applied to the transmitting electrodes 2 by the transmitter 5; and that the amplitude phase of voltage signals is substantially matched, the voltage signals corresponding to the rise of one pulse wave and the fall of the next pulse wave.

Specifically, a waveform B1 is superimposed onto a waveform A2, the waveform B1 being formed by discharging on the fall of one pulse wave, the waveform A2 being formed by discharging (transient response) on the rise of the same pulse wave; and a waveform A3 is superimposed onto a waveform B2, the waveform A3 being formed by charging on the rise of one pulse wave, the waveform B2 being formed by charging (transient response) on the fall of the preceding pulse wave.

Thereby, substantially amplified waveforms are obtained as shown in FIG. 6(b). The signal output from the IV converter 31 shows a sine wave and has a frequency component identical to that of the pulse signal applied to the transmitting electrodes 2.

Such a conversion property can be obtained by adjusting a time constant (a value for adjusting timing of charges and discharges) of a conversion circuit in the IV converter 31. The time constant is determined in the IV converter 31 based the resistance value of the resistance component R and the capacitance values of the first and second capacitor components C1 and C2. Adjusting the time constant provides the conversion property that achieves amplification by matching the amplitude phase, as shown in FIG. 6(b). It is also possible to set the components, including the resistance value or the capacitance values, to 0, for example, the capacity value of the second capacitor component C2 to 0.

To achieve the signal amplification, it is preferable to set the time constant of the IV converter 31 to a value appropriate for the frequency of the pulse signal applied to the transmitting electrodes 2. However, the frequency cannot be strictly optimized according to the varying time constant. Due to a small adjustment width in changing the frequency of the pulse signal, there is no significant impact to the signal amplification even if the time constant is not changed, in particular, according to the change in the frequency.

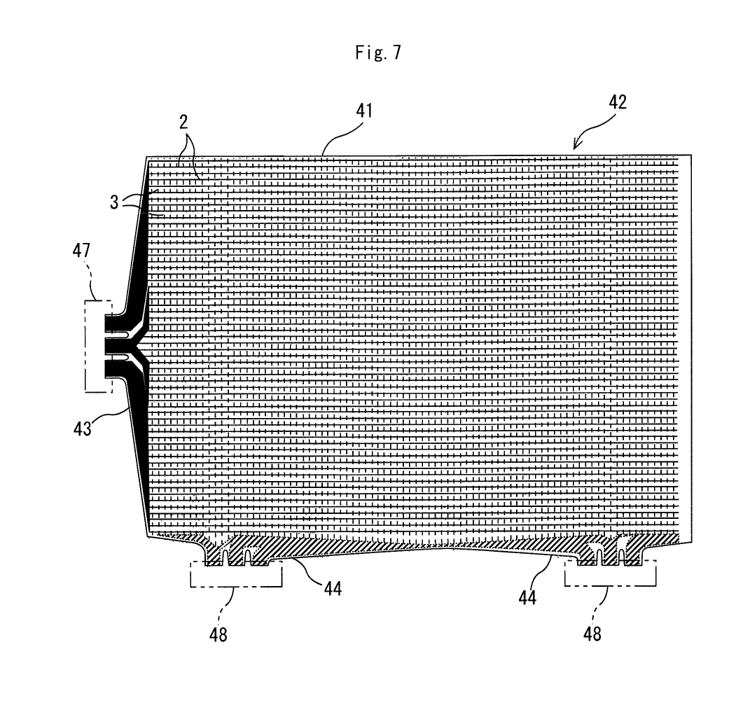

FIG. 7 is a plan view of an electrode sheet 42 included in the panel main body 4 shown in FIG. 1. The transmitting electrodes 2 and the receiving electrodes 3 are provided on the front and rear surfaces of a support sheet 41, which can be, as a non-limiting example, be composed of a flexible synthetic resin material. The support sheet 41, the transmitting electrodes 2, and the receiving electrodes 3 are integrated into the electrode sheet 42.

The electrode sheet 42 is integrally provided with a transmission extractor 43 in a portion extending from the left end portion of the support sheet 41, the transmission extracter 43 being provided with leading lines that connect the transmitting electrodes 2 and the transmitter 5. Furthermore, the electrode sheet 42 is integrally provided with reception extractors 44 in a portion extending from the lower end portion of the support sheet 41, the reception extractors 44 being provided with leading lines that connect the receiving electrodes 3 and the receiver 6. In the embodiment, as a non-limiting example, one transmission extracter 43 and two reception extractors 44 are provided. However, other numbers and alternations of the extractors can be provided.

The transmission extracter 43 is connected to one transmission board 47 included in the transmitter 5. The reception extractors 44 are connected to two reception boards 48 included in the receiver 6. In order to reduce the external dimensions of the panel main body 4, the transmission board 47 and the reception boards 48 are provided on the rear surface of the transmitting electrodes 2 and the receiving electrodes 3, and the transmission extracter 43 and the reception extractors 44 are folded to the rear side and then connected to the transmission board 47 and the reception boards 48.

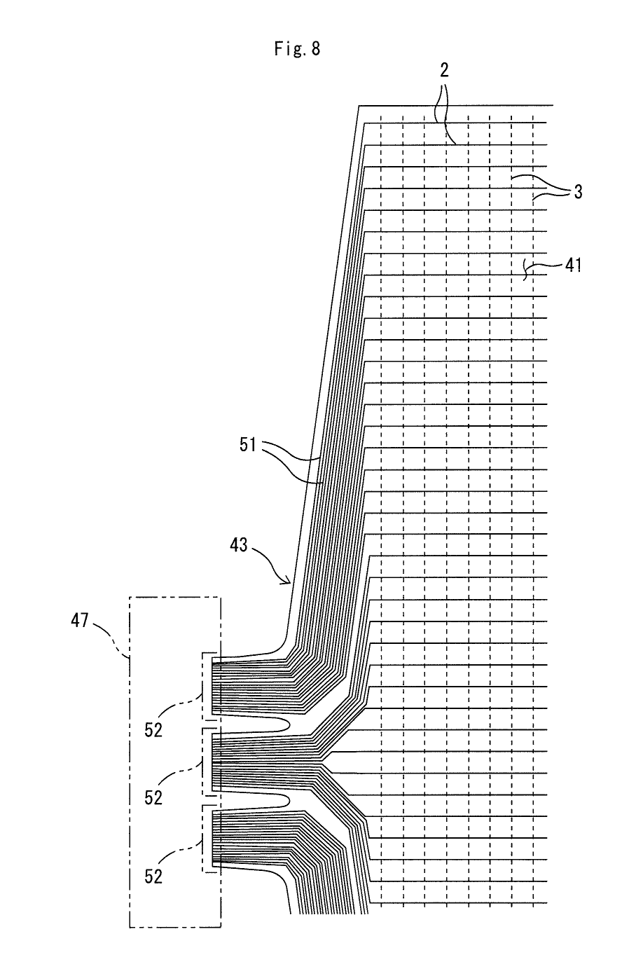

FIG. 8 is a plan view illustrating in details the transmission extractor 43 of the electrode sheet 42 shown in FIG. 7. The transmission extractor 43 is provided with the leading lines 51 that connect the transmitting electrodes 2 and the transmission board 47. The leading lines 51 are collected substantially radially from one end extending from the transmitting electrodes 2 toward the other end to which the transmission board 47 is connected so as to fit a width of a connector 52 of the transmission board 47.

Substantially radially collecting the leading lines 51 reduces the number of transmission boards 47, and shortens the entire length of each of the leading lines 51, which connect the transmitting electrodes 2 and the transmission board 47 through paths having substantially the shortest distance.

The entire length of the leading lines 51 varies according to a positional relationship between the transmission board 47 and the transmitting electrodes 2. The longer the distance is between the transmission board 47 and the transmitting electrode 2, the longer the entire length of the leading line 51 is. The leading lines 51 corresponding to the transmitting electrode 2 in the central portion in the Y direction (array direction of the transmitting electrodes 2) are the shortest, and the leading lines 51 become gradually longer toward the ends in the Y direction and are the longest at the ends in the Y direction.

An upper portion from the central portion of the transmission extractor 43 is shown in FIG. 8. A lower portion is provided substantially symmetrically. Similar to the transmission extractor 43, the reception extractors 44 in FIG. 7 are provided with leading lines that connect the receiving electrodes 3 and the reception boards 48. The leading lines are collected substantially radially from one end extending from the receiving electrodes 3 toward the other end where the lines are connected to the reception boards 48 is connected so as to fit the width of the reception boards 48.

The touch screen device 1, which is used as an interactive whiteboard, has a large size and thus long transmitting electrodes 2 and receiving electrodes 3. The impedance associated with the transmitting electrodes 2 and the receiving electrodes 3 is likely to vary significantly.

In particular, in the case where the leading lines 51 are collected toward the transmission board 47, as shown in FIG. 8, the leading lines 51 become longer from the central portion toward the ends in the Y direction (array direction of the transmitting electrodes 2), thus causing a significant variation in the impedance of the transmitting electrodes 2. Accordingly, a significant variation is observed, depending on a Y direction position, in the level signal at each electrode intersection detected in a non-touch state in which no touch operation is performed. Furthermore, the leading lines on the reception side are wired in a similar manner, thus causing a significant variation in the level signal, depending on a X direction position (array position of the receiving electrodes 3). Due to the variation in the level signal in the non-touch state, accuracy in detecting a touch position becomes deteriorated.

In the embodiment, the number of pulses of one receiving electrode 3, specifically the number of pulses applied to the transmitting electrodes 2 during reception of an output signal of one receiving electrode 3, is changed according to the variation in the level signal in the non-touch state to reduce the variation in the level signal in the Y direction. The gain at the gain adjuster 33 in the reception signal processor 22 is changed to deal with the variation in the level signal in the X direction.

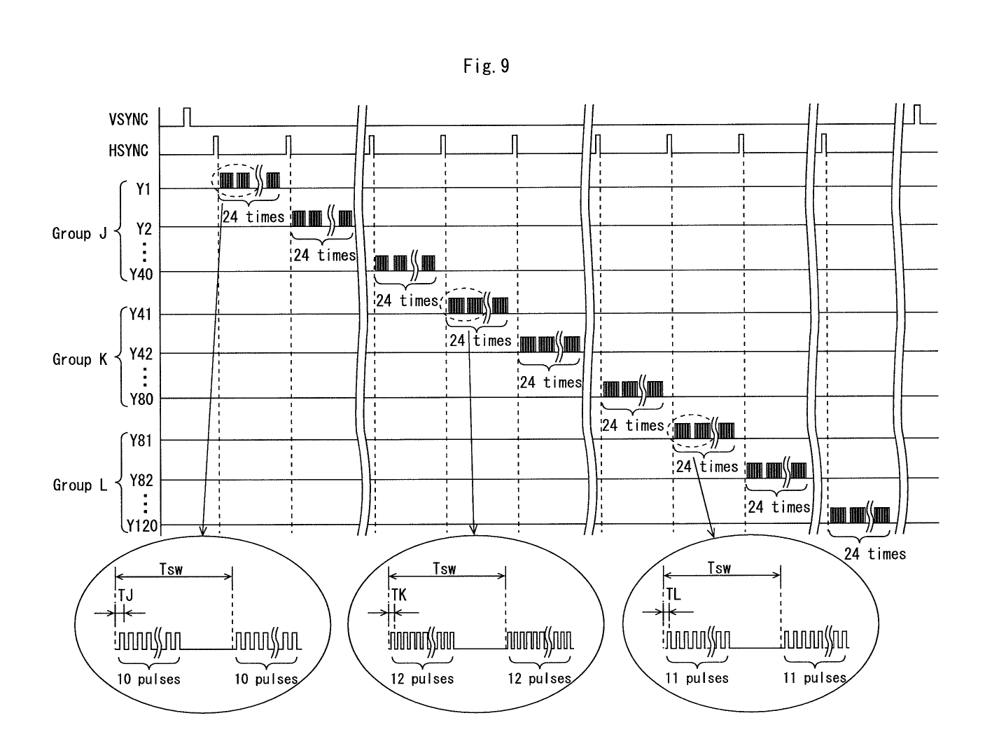

FIG. 9 illustrates a state in which a pulse signal is applied to the transmitting electrodes 2 in the transmitter 5 shown in FIG. 2. In the drawing, 120 transmitting electrodes 2 are shown as Y1, Y2, . . . Y120 from the end and are grouped into three groups of J, K, and L every 40 pieces.

A vertical synchronization signal (VSYNC) that defines a start timing of one frame is first output from the controller 7 to the transmitter 5. Subsequently, a horizontal synchronization signal (HSYNC) that defines a timing to apply a pulse signal to each of the transmitting electrodes 2 is output from the controller to the transmitter 5. A pulse signal is applied to the transmitting electrodes 2 according to the horizontal synchronization signal (HSYNC).

In the process, a pulse group including a predetermined number of pulses that corresponds to one receiving electrode 3 is repeatedly applied to one transmitting electrode 2 24 times, in accordance with the number of the receiving electrodes 3 belonging to one group. In the receiver 6, output signals from 24 receiving electrodes 3 belonging to one group are sequentially input from the electrode selector 21 to the reception signal processor 22. Signals corresponding to one another from each group are processed in parallel.

The number of pulses of one receiving electrode 3, specifically the number of pulses applied to the transmitting electrodes 2 during reception of an output signal of one receiving electrode 3, is set for each group of the transmitting electrodes 2 corresponding to the frequency of the pulse signal. In the illustrated example, the number of pulses of one receiving electrode 3 is set to 10 for group J, 12 for group K, and 11 for group L. In switching of the group of the transmitting electrodes 2, the controller 7 sets a frequency assigned to a new group in the set value holder 11 of the transmitter 5. Thus, the pulse signal is output at a frequency set for each group.

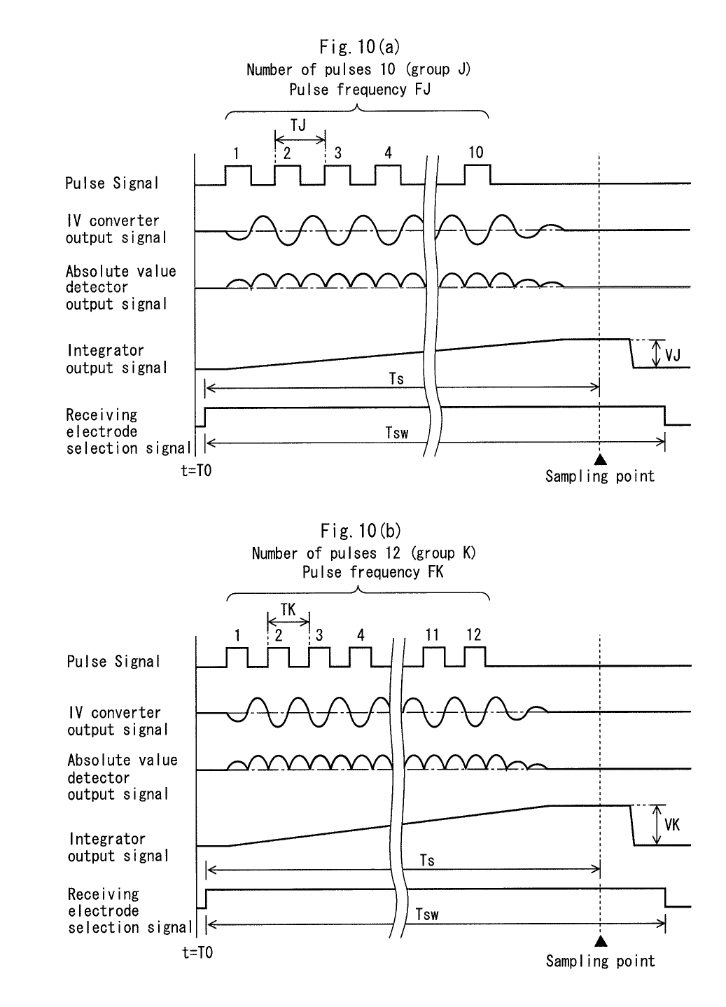

FIGS. 10(a) and 10(b) illustrate a pulse signal applied to the transmitting electrodes 2 shown in FIG. 2; output signals from the IV converter 31, the absolute value detector 34, and the integrator 35, respectively, of the reception signal processor 22 of the receiver 6 shown in FIG. 4; and a selection signal of the receiving electrodes 3. The signals are detected in a non-touch state in which no touch operation is performed.

A pulse signal is applied to the transmitting electrodes 2, and then an output signal indicating a sine wave is output from the IV converter 31 in response. The output signal undergoes full-wave rectification at the absolute value detector 34 and is integrated at the integrator 35. An output signal from the integrator 35 is sampled at a timing of a predetermined integration period Ts (sampling point) in the sampler/holder 36, and then a sampling voltage V is output. The sampling voltage V is AD-converted in the AD converter 37 and output to the controller 7 as a level signal.

FIG. 10(a) illustrates a case of group J of the transmitting electrodes 2 with a number of pulses of one receiving electrode 3 of 10. FIG. 10(b) illustrates a case of group K of the transmitting electrodes 2 with a number of pulses of one receiving electrode 3 of 12. A sampling voltage VK in the case of the number of pulses of 12 of one receiving electrode 3 is greater than a sampling voltage VJ in the case of the number of pulses of 10 (VK>VJ). Increasing the number of pulses of one receiving electrode 3 increases the sampling voltage V.

As shown in FIGS. 6(a) and 6(b), amplification by matching the amplitude phase is performed so as to amplify the output signal indicating a sine wave from the IV converter 31 at the same cycle as the pulse signal applied to the transmitting electrodes 2. Increasing the number of pulses of one receiving electrode 3 increases the amplitude of the output signal of the IV converter 31, thus increasing the sampling voltage V provided from rectification and integration of the output signal of the IV converter 31.

As described above, changing the number of pulses of one receiving electrode 3 changes the sampling voltage V, specifically the level signal. Setting the number of pulses for each group of the transmitting electrodes 2 according to the variation of the level signal detected in a non-touch state reduces the variation of the level signal.

Furthermore, the frequency of the pulse signal is set to be higher, as the number of pulses of one receiving electrode 3 increases. In the illustrated example, a frequency FK in the case of a number of pulses of one receiving electrode 3 of 12 is set to be higher than a frequency FJ in the case of a number of pulses of 10 (FK>FJ). Thereby, application of pulses can be completed within substantially the same time, thus requiring no change of the sampling point. Even if the number of pulses of one receiving electrode 3 is changed, the signal processing time is the same for each receiving electrode 3, thus facilitating control.

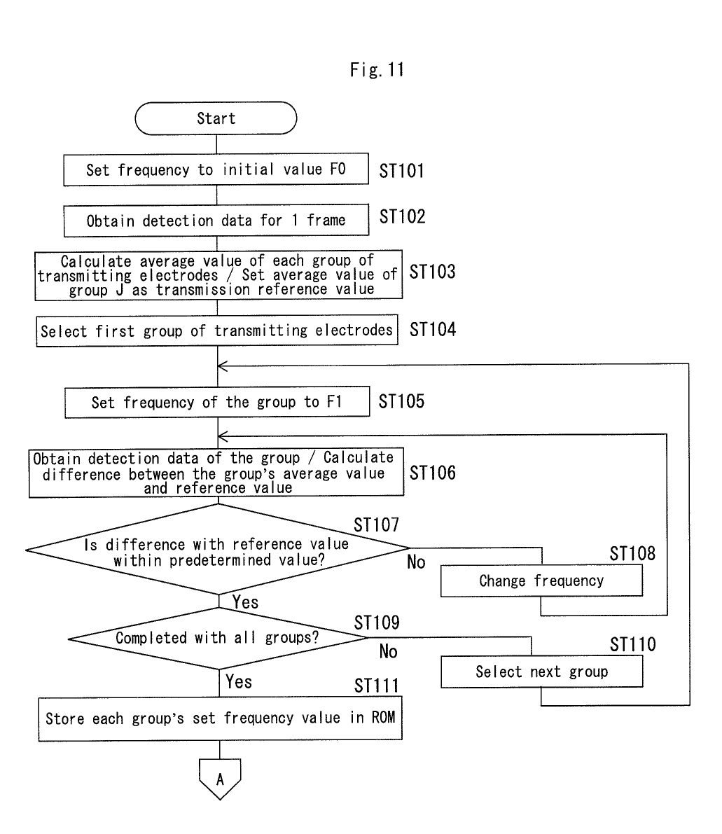

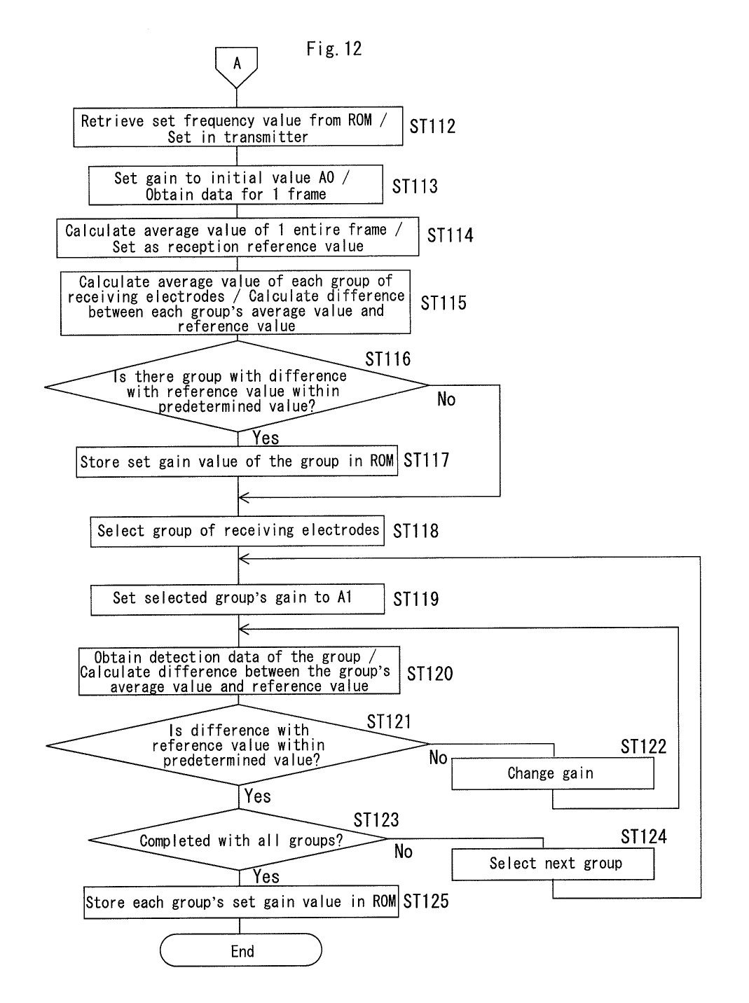

FIG. 11 is a flowchart illustrating a procedure to set a frequency of a pulse signal applied to the transmitting electrodes 2 for each group of the transmitting electrodes 2 in the controller 7 shown in FIG. 2. FIG. 12 is a flowchart illustrating a procedure to set a gain for each group of the receiving electrodes 3 in the controller 7 shown in FIG. 2, the gain amplifying an output signal from the receiving electrodes 3 in the gain adjuster 33.

A frequency is first determined for each group of the transmitting electrodes 2, the frequency corresponding to an optimum number of pulses to include a variation of detection data (level signal) in the Y direction (array direction of the transmitting electrodes 2) within a tolerance range. Then, an optimum gain is determined for each group of the receiving electrodes 3 to include a variation of detection data in the X direction (array direction of the receiving electrodes 3) within a tolerance range.

A process to determine a frequency for each group of the transmitting electrodes 2 in the controller 7 is first explained with reference to FIG. 11. A frequency of a pulse signal applied to the transmitting electrodes 2 is first set to an initial value F0 (5 MHz, for example) (ST101). The pulse signal is applied to the transmitting electrodes 2 and an output signal of the receiving electrodes 3 is received and processed for one frame. Then, an average value of detection data is calculated for each group of the transmitting electrodes 2 and an average value of a predetermined group (group J, for example) is set as a transmission reference value (ST102 and ST103).

Subsequently, an optimum frequency that includes a variation of the detection data within a tolerance range is retrieved from candidate values F1 to Fn. The frequency is then stored in the ROM of the controller 7 as a set frequency value of the group (ST104 to ST111). Whether the variation of the detection data falls within the tolerance range is performed by comparing the average value of the detection data of each group and the transmission reference value. When the difference between the values is within a predetermined threshold value, it is determined that the variation falls within the tolerance range.

In the process above of obtaining the detection data (level signal), the gain of the gain adjuster 33 in each reception signal processor 22 in the receiver 6 is set to an initial value A0.

The frequency of each group of the transmitting electrodes 2 is determined as above. Since the transmission reference value is the average value of a predetermined group that serves as a reference to determine whether the variation of the detection data falls within the tolerance range, the set frequency value of the reference group is the initial value F0 and frequencies for other groups are set such that the difference of the detected data is small, relative to the reference group.

In the process, the frequency is set in a unit of group of the transmitting electrodes 2 and the transmitting electrodes 2 in the group are set to the same frequency. Thus, the variation of the detected data within the group is not corrected. A variation in impedance related to the transmitting electrodes 2, which causes the variation of the detected data, depends on a position of the transmitting electrodes 2 and gradually varies along the Y direction (array direction of the transmitting electrodes 2). Thus, setting the frequency even in a unit of group provides sufficient effect.

A process to determine a gain for each group of the receiving electrodes 3 in the controller 7 is explained below with reference to FIG. 12. The frequency of each group determined in the preceding process is first set in the set value holder 11 of the transmitter 5 (ST112). In the subsequent process of obtaining the detection data (level signal), the pulse signal of the frequency set for each group is applied to the transmitting electrodes 2.

Subsequently, the gain of the gain adjuster 33 in the reception signal processor 22 provided for each group of the receiving electrodes 3 is all set to the initial value A0. A pulse signal is then applied to the transmitting electrodes 2 and an output signal of the receiving electrodes 3 is received and processed for one frame. Then, an average value of detection data of one entire frame is calculated and the average value is set as a reception reference value (ST113 and ST114).

Subsequently, when there is a group whose variation of detection data falls within a tolerance range at the gain initial value A0, specifically a group whose optimum gain is the initial value A0, the gain is stored in the ROM of the controller 7 as a set gain value of the group (ST115 to ST117). Whether the variation of the detection data falls within the tolerance range is performed by comparing the average value of the detection data of each group and the reception reference value. When the difference between the values is within a predetermined threshold value, it is determined that the variation falls within the tolerance range.

Subsequently, an optimum gain that includes a variation of the detection data within the tolerance range is retrieved from candidate values A1 to An for each group other than the group whose optimum gain is the initial value A0. The gain is then stored in the ROM of the controller 7 as a set gain value of the group (ST118 to ST125). Whether the variation of the detection data falls within the tolerance range is performed by comparing the average value of the detection data of each group and the reception reference value, similar to above. When the difference between the values is within a predetermined threshold value, it is determined that the variation falls within the tolerance range.

The operations above are performed in a state where no touch operation is performed, such as an adjustment process during the production of the device. Once the device is activated for actual use, the set frequency values and the set gain values are retrieved separately, from the ROM of the controller 7, and set to the set value holder 11 of the transmitter 5 and the reception signal processor 22 of the receiver 6. The transmitter 5 and the receiver 6 operate based on the set values.

Thereby, the optimum frequency is determined for each group of the transmitting electrodes 2, the optimum frequency including the variation of the detection data in the Y direction (array direction of the transmitting electrodes 2) within the tolerance range; and the optimum gain is determined for each group of the receiving electrodes 3, the optimum gain including the variation of the detection data in the X direction (array direction of the receiving electrodes 3) within the tolerance range.

As shown in FIG. 2, the touch surface 10 is divided into 24 areas of R11 to R18, R21 to R28, and R31 to R38, by three groups J to L of the transmitting electrodes 2 and eight groups A to H of the receiving electrodes 3. Controlling the frequency of the pulse signal and the gain of the reception signal in a unit of group allows adjustment of the level signal at each two-dimensionally arranged electrode intersection in a unit of area.

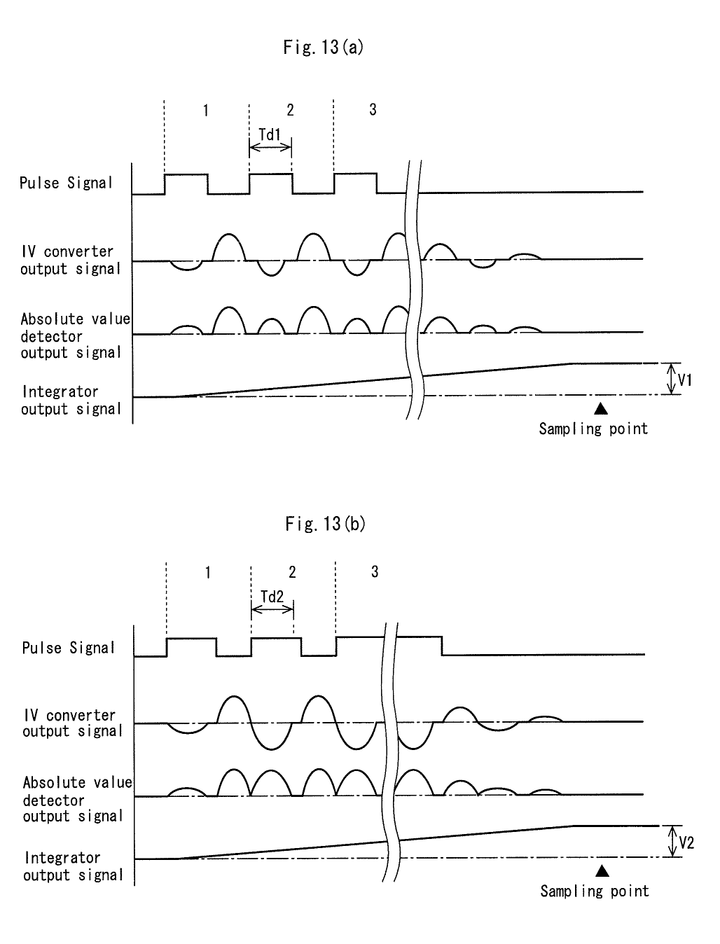

FIGS. 13(a) and 13(b) illustrate a state of pulse signal control based on the on-duty ratio in the controller 7 shown in FIG. 2. A pulse signal applied to the transmitting electrodes 2 and output signals from the IV converter 31, the absolute value detector 34, and the integrator 35, respectively, of the reception signal processor 22 in the receiver 6 are indicated in FIGS. 13(a) and 13(b).

The on-duty ratio of the pulse signal applied to the transmitting electrodes 2 is changed. FIG. 13(a) illustrates a case of an on-duty ratio of 50%. FIG. 13(b) illustrates a case of an on-duty ratio of greater than 50%. The PLL synthesizer 16 shown in FIG. 3 is configured to change the on-duty ratio of the pulse signal. A set duty value referred to by the PLL synthesizer 16 is held at the set value holder 11. The set duty value is set in the controller 7.

The pulse signal is generally output at an on-duty ratio of 50%. Depending on the frequency of the pulse signal, a waveform of a signal output from the IV converter 31 may be distorted in response to the rise and fall of the pulse signal, as shown in FIG. 13(a), because of the difference in the time constant of the IV converter 31 or the impedance of the transmitting electrodes 2. In this case, the on-duty ratio of the pulse signal is changed, as shown in FIG. 13(b), and thus the phase of the response waveform is fine-tuned. Thereby, the amplitude phase becomes substantially the same, and the waveform of the output signal from the IV converter 31 is brought much closer to a sine wave.

The change of the waveform of the output signal from the IV converter 31 affects the sampling voltage V. Changing the on-duty ratio of the pulse signal changes the sampling voltage V, thus reducing the variation of the level signal.

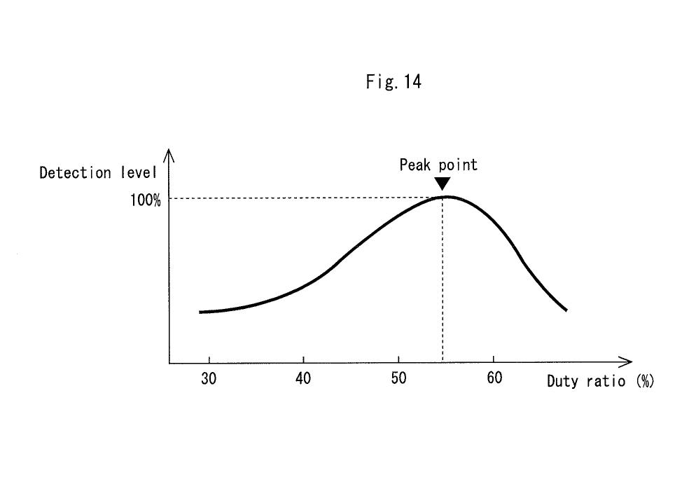

FIG. 14 illustrates a relationship between the on-duty ratio and the level signal in the pulse signal control based on the on-duty ratio in FIGS. 13(a) and 13(b). The level signal peaks at an on-duty ratio of around 55%. In the area below the on-duty ratio peak, the level signal gradually increases according to an increase of the on-duty ratio and suddenly decreases at an on-duty ratio of exceeding around 60%. It is thus desirable to adjust the on-duty ratio in a range between 40% and 60%. The property (duty ratio) changes according to the time constant of the IV converter 31 and other factors.

In the control above in which the frequency of the pulse signal is changed, the level signal can be adjusted freely. Since the number of pulses of one receiving electrode 3 is adjusted, however, the adjustment of the level signal is phased. Meanwhile, in the control in which the on-duty ratio is changed, although the adjustment width of the level signal is small, the level signal can be finely tuned. Thus, it is preferable that the level signal be roughly adjusted by changing the frequency (pulse signal), and then finely adjusted by changing the on-duty ratio.

In the case where the variation of the level signal is small, changing the on-duty ratio may suffice.

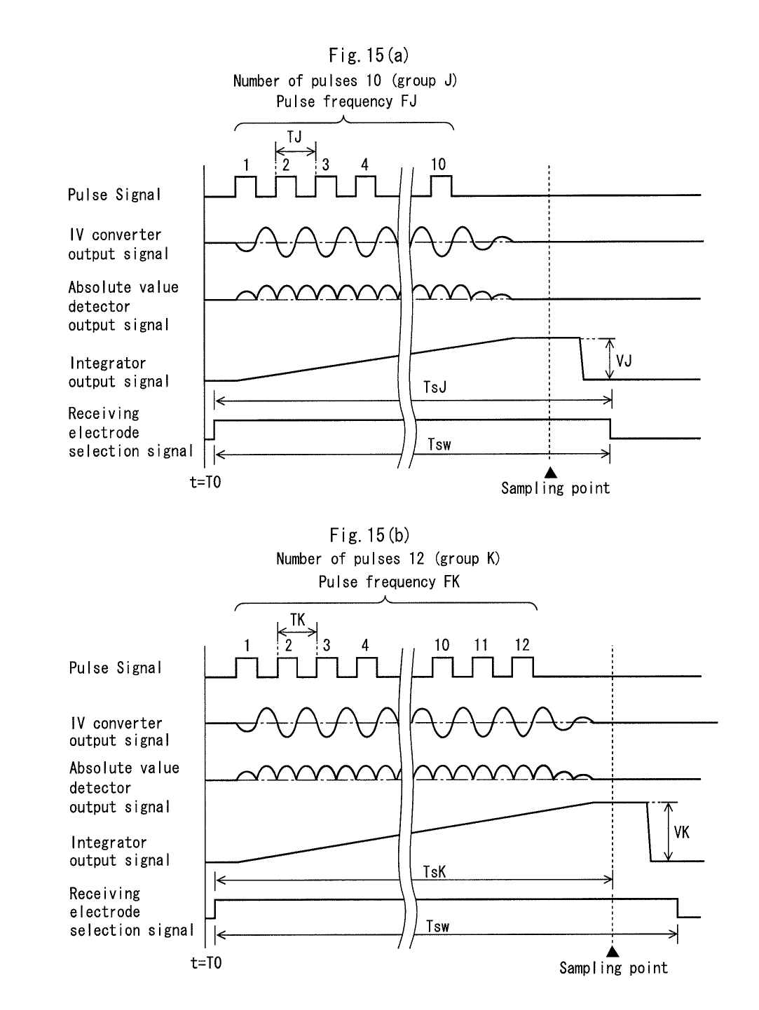

FIGS. 15(a) and 15(b) illustrate another example of pulse signal control in the touch screen device of the present invention. Similar to FIGS. 10(a) and 10(b), FIGS. 15(a) and 15(b) include a pulse signal applied to the transmitting electrodes 2; output signals from the IV converter 31, the absolute value detector 34, and the integrator 35, respectively, of the reception signal processor 22 of the receiver 6; and a selection signal of the receiving electrodes 3. Only differences from the embodiment above are explained below; other components of the configuration are similar to those in the embodiment above.

The frequency of the pulse signal applied to the transmitting electrodes 2 is set to be constant (FK=FJ) (5 MHz, for example), and the number of pulses of one receiving electrode 3 is changed. FIG. 15(a) illustrates the case of group J of the transmitting electrodes 2 with 10 pulses of one receiving electrode 3. FIG. 15(b) illustrates the case of group K of the transmitting electrodes 2 with 12 pulses of one receiving electrode 3. The sampling voltage VK in the case of the number of pulses of 12 of one receiving electrode 3 is greater than the sampling voltage VJ in the case of the number of pulses of 10 (VK>VJ). Increasing the number of pulses of one receiving electrode 3 increases the sampling voltage V.

In this case, a time to complete applying all pulses varies depending on the number of pulses of one receiving electrode 3. A time is secured in a similar manner from the completion of the last pulse application until the output is stabilized, and a sampling point is set. Then, the sampling point varies depending on the number of pulses. As shown in FIG. 15(a), the sampling point occurs earlier in the case 10 pulses than in the case of 12 pulses shown in FIG. 15(b). Thus, a time required to process one frame is shortened, and a touch position can be detected at a high speed.

As described above, changing only the pulse number of one receiving electrode 3 while not changing the frequency of the pulse signal simplifies the configuration of the pulse generator 12.

The touch screen device according to the present invention, which detects a touch position at a high accuracy even in a large size device, is useful as a electrostatic capacitance touch screen device, particularly a mutual capacitance touch screen device.

It is noted that the foregoing examples have been provided merely for the purpose of explanation and are in no way to be construed as limiting of the present invention. While the present invention has been described with reference to exemplary embodiments, it is understood that the words which have been used herein are words of description and illustration, rather than words of limitation. Changes may be made, within the purview of the appended claims, as presently stated and as amended, without departing from the scope and spirit of the present invention in its aspects. Features of the various disclosed embodiments may be combined: although the present invention has been described herein with reference to particular structures, materials and embodiments, the present invention is not intended to be limited to the particulars disclosed herein; rather, the present invention extends to all functionally equivalent structures, methods and uses, such as are within the scope of the appended claims.

The present invention is not limited to the above described embodiments, and various variations and modifications may be possible without departing from the scope of the present invention.

What is claimed is:

1. A touch screen device comprising:
a panel main body comprising a plurality of transmitting electrodes provided in parallel to one another and a plurality of receiving electrodes provided in parallel to one another, the transmitting electrodes and the receiving electrodes being disposed in a grid shape;
a transmitter that applies pulse signals to the transmitting electrodes;
a receiver that receives output signals from the receiving electrodes in response to the pulse signals applied to the transmitting electrodes and outputs level signals at electrode intersections of the transmitting electrodes and the receiving electrodes; and
a controller that detects a touch position based on the level signals output from the receiver and controls a number of pulses of a pulse signal that the transmitter applies to each transmitting electrode while the receiver receives an output signal from each receiving electrode.

2. The touch screen device according to claim 1, wherein the transmitting electrodes are combined into groups, and a same number of pulses are applied to transmitting electrodes in a same group, while the receiver receives an output signal from each receiving electrode.

3. The touch screen device according to claim 1, wherein the controller controls the number of pulses of a pulse signal that the transmitter applies to each transmitting electrode while the receiver receives an output signal from each receiving electrode such that a variation of the level signals in a non-touch state falls within a tolerance range.

4. The touch screen device according to claim 1, wherein the transmitter is configured to change frequencies of the pulse signals.

5. The touch screen device according to claim 4, wherein the higher the number of pulses of a pulse signal that the transmitter applies to each transmitting electrode while the receiver receives an output signal from each receiving electrode, the higher is a frequency of the pulse signal.

6. The touch screen device according to claim 1, wherein the frequencies of the pulse signals are constant.

7. The touch screen device according to claim 1, wherein the controller controls an on-duty ratio of the pulse signals.

8. The touch screen device according to claim 7, wherein the controller controls on-duty ratio of the pulse signals to be in a range between about 40% and 60%.

9. The touch screen device according to claim 1, wherein the receiver comprises an amplifier amplifying the output signals from the receiving electrodes, and the controller controls gains in the amplifier.

10. The touch screen device according to claim 9, wherein the receiving electrodes are combined into groups, and a same gain is used for the receiving electrodes in a same group.

11. The touch screen device according to claim 9, wherein the controller controls the gains such that a variation of the level signals in a non-touch state falls within a tolerance range.

12. The touch screen device according to claim 1, wherein the number of pulses of one receiving electrode, which is the number of pulses applied to the transmitting electrode during reception of an output signal of a receiving electrode, is changed in accordance with a variation in the level signal in a non-touch state.
